(19) United States
(12) Patent Application Publication
(10) Pub. No.: US 2022/0379434 A1
(43) Pub. Date: Dec. 1, 2022

(54) ANGLE GRINDER

(71) Applicant: NewGrind Inc., Coquitlam (CA)

(72) Inventor: Owen Rogers, Surrey (CA)

(21) Appl. No.: 17/826,044

(22) Filed: May 26, 2022

Related U.S. Application Data
(60) Provisional application No. 63/195,113, filed on May 31, 2021.

(51) Int. Cl. B24B 55/05; B24B 23/02; B25F 5/02

(52) U.S. Cl. CPC B24B 55/052; B24B 23/028; B25F 5/02

(57) ABSTRACT

An angle grinder head is provided. The angle grinder head includes a drive shaft; a drive assembly including a drive head and a drive plate, the drive head coupled to the shaft; an outer shroud including a vacuum port for attaching to a vacuum hose and a opening through which the drive shaft extends; and a bearing assembly including a bearing housing and an inner race. The inner race is disposed between the drive shaft and the drive head. The bearing housing is fixedly connected to the outer shroud. The outer shroud and the bearing housing are independently rotatable in relation to the drive shaft, drive assembly, and inner race.

### TECHNICAL FIELD

This invention generally relates to angle grinders.

### BACKGROUND

Angle grinders are a commonly used for grinding and polishing concrete surfaces, masonry surfaces and the like.

A common problem with existing angle grinders is the lack of efficient dust control. Grinding and polishing generates a large amount of dust that can be hazardous to the operator and necessitates additional time for cleanup. Shrouds for covering the angle grinder head, where a vacuum hose is attached to shroud, are known. However existing shrouds have problems such as insufficient vacuuming, and the vacuum hose interfering with the operator freely and efficiently moving of the angle grinder.

Another common problem is uneven cutting and gouging of the surface when grinding or polishing contoured surfaces or rough patches. One known angle grinder configuration uses a diamond cup wheel rigidly and directly mounted by an arbor to the motor of the angle grinder. Such configurations, when forcibly run over contoured or even over relatively flat surfaces, result in issues such as overheating, stalling, or “jumping” (which can cause tool marks damaging the surface).

Yet another common problem is infiltration of dust, dirt and debris into angle grinder components such as the bearings of the angle grinder head, and also into the cooling ports of the motor causing premature wear of the brushes, armature and motor bearings.

Improved grinders which address at least some of these problems are desirable.

### SUMMARY

This invention has a various aspects.

In one aspect, an angle grinder head is provided. The angle grinder head includes a drive shaft; a drive assembly having a drive head and a drive plate, the drive head coupled to the shaft; an outer shroud having a vacuum port for attaching to a vacuum hose; and a opening through which the drive shaft extends; a bearing assembly comprising a bearing housing and an inner race; wherein the inner race is engaged between the drive shaft and the drive head; wherein the bearing housing is fixedly connected to the outer shroud; whereby the outer shroud and the bearing housing are independently and freely rotatable in relation to the drive shaft, drive assembly, and inner race.

The drive shaft may include an upper portion, wherein the inner race is engaged between a shoulder of the upper portion and the drive head.

The drive assembly may include a thrust washer, wherein the drive head includes a shoulder for seating the thrust washer, and wherein the inner race is engaged between the shoulder of the upper portion and the thrust washer.

An inner shroud may be fixedly connected to the bearing housing, the inner shroud including a opening through which the drive assembly extends, the inner shroud and outer shroud defining a cavity therebetween.

A sidewall of the outer shroud and/or a sidewall of the inner shroud may taper toward each another in the downward direction, whereby the cavity between the sidewall of the outer shroud and the sidewall of the inner shroud narrows in the downward direction to define a gap between the outer shroud and a lower edge of the inner shroud. The gap may be annular. The gap may be between about 0.5 mm and 10 mm, or between about 1 mm and 5 mm.

A sidewall of the outer shroud may extend lower than the sidewall of the inner shroud, and wherein the inner shroud tapers toward the outer shroud at an angle between about 10 degrees to 30 degrees, or about 15 degrees to 25 degrees, or about 20 degrees.

An annular seal plate may be fixedly connected to the inner shroud, wherein an axle seal is disposed between the seal plate and the drive head to seal the bearing assembly.

The bearing housing may be fittingly disposed between the outer shroud and the inner shroud to seal the bearing assembly.

The outer shroud may be cylindrical, the inner shroud is frustoconical, and the inner shroud may be concentrically disposed within the outer shroud.

An array of resilient grommets in multiples of three may be disposed in a plurality of openings in the drive plate, the resilient grommets configured to attach to a tool plate. The resilient grommets may be made of rubber.

In another aspect, an angle grinder is provided. The angle grinder includes: a housing; a motor inside the housing; a handle projecting from the housing; an angle grinder head as described herein, wherein the drive shaft of the angle grinder is drivingly connected to the motor; and a tool assembly detachably connected to the drive plate of the angle grinder.

It is emphasized that the invention relates to all combinations of the above features, with one another and/or with other features that are described elsewhere herein and/or depicted in the drawings even if these are recited in different claims, different paragraphs and/or different sentences.

In addition to the exemplary aspects and embodiments described above, further aspects and embodiments will become apparent by reference to the drawings and by study of the following detailed descriptions.

### BRIEF DESCRIPTION OF DRAWINGS

The accompanying drawings illustrate non-limiting example embodiments of the invention.

FIG. 1 is a cross-sectional side view of an angle grinder head according to an embodiment.

FIG. 2 is a bottom perspective view of an outer shroud of the angle grinder head shown in FIG. 1.

FIG. 3A is a bottom perspective view of an inner shroud of the angle grinder head shown in FIG. 1.

FIG. 3B is a side view of an inner shroud of the angle grinder head shown in FIG. 1.

FIG. 4 is a bottom perspective view of a drive shaft of the angle grinder head shown in FIG. 1.

FIG. 5 is a top perspective view of a drive assembly of the angle grinder head shown in FIG. 1.

FIG. 6 is a photographic partial top view of an angle grinder according to an embodiment.

FIG. 7 is a photographic partial bottom view of the angle grinder shown in

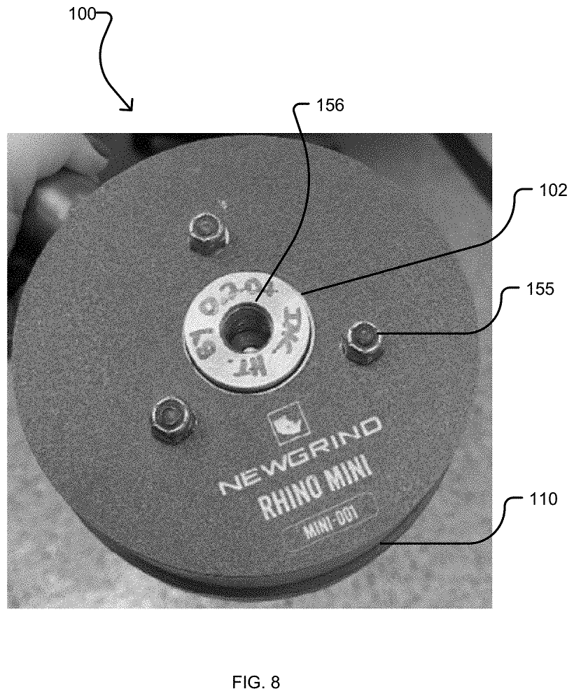

FIG. 6 with a tool assembly attached.

FIG. 8 is a photographic top view of the angle grinder head of the angle grinder shown in FIG. 6.

FIG. 9 is a photographic bottom view of the angle grinder head of the angle grinder shown in FIG. 6 with the tool assembly removed.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Some aspects of the invention relate to an angle grinder head with a shroud that is independently and freely rotatable in relation to the drive components to eliminate restriction of movement caused by interference by the vacuum hose. Some aspects relate to angle grinder heads with an inner shroud and an outer shroud configured to limit the size of the entrance to a cavity defined therebetween to increase efficiency of vacuuming of dust. Some aspects relate to angle grinder heads with a seal plate and axle seal to protect the bearings from particulate matter. Some aspects relate to angle grinder heads with resilient grommets for connecting the tool assembly to the drive plate to provide flexibility and smooth movement of the tool plate over contours and uneven surfaces. Some aspects relate to angle grinders incorporating such angle grinder heads.

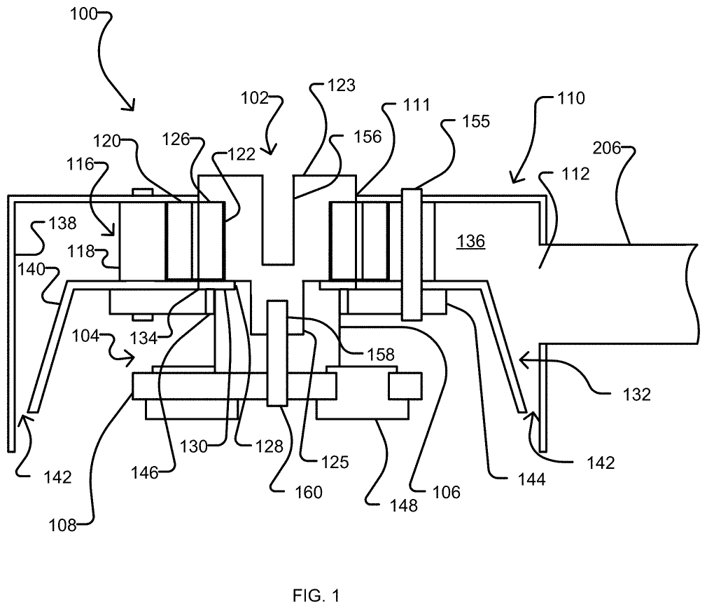

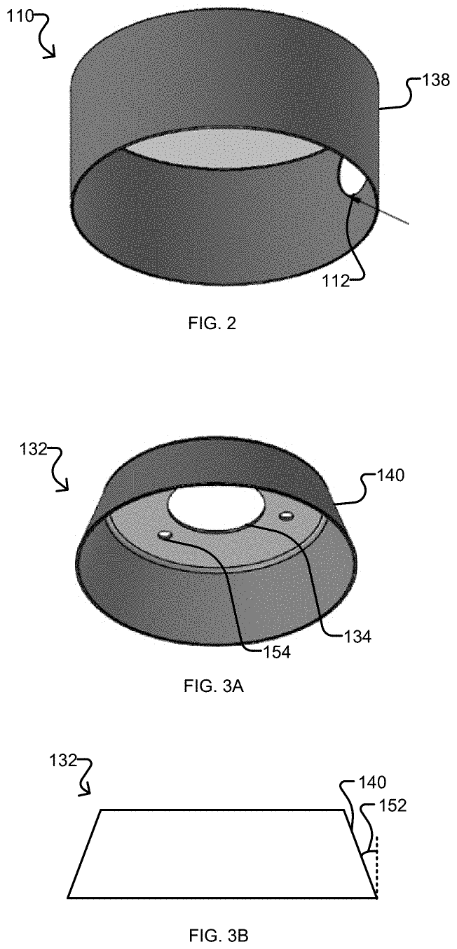

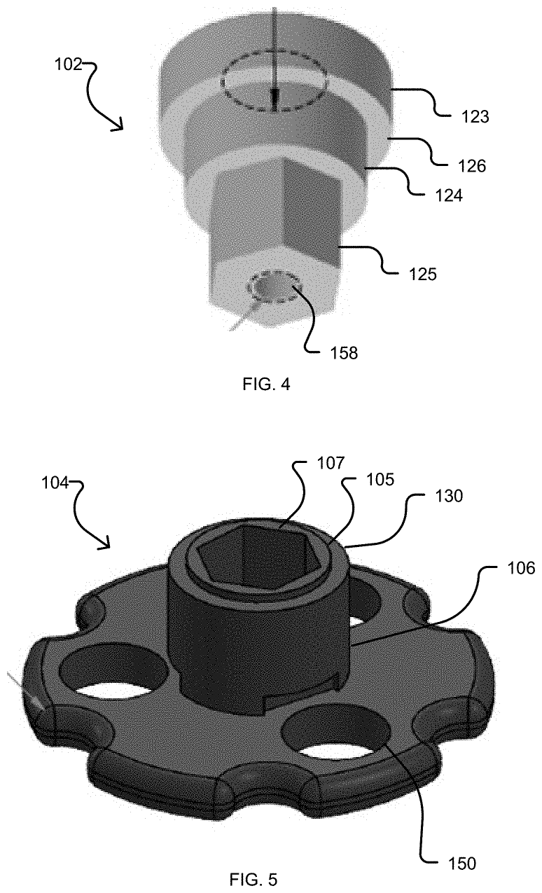

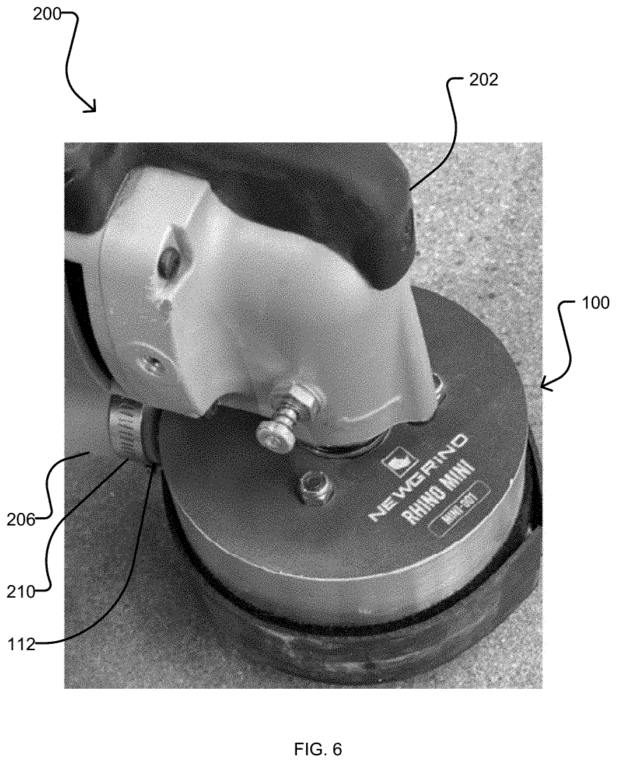

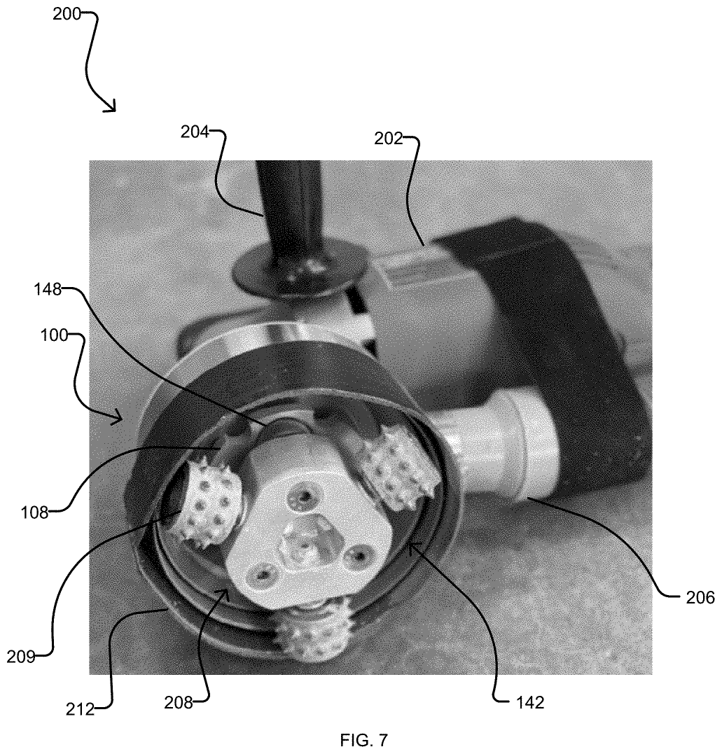

FIGS. 1 to 5 show an angle grinder head 100 according to an embodiment.

Angle grinder head 100 has a drive shaft 102 and a drive assembly 104. Drive assembly 104 includes a drive head 106 and a drive plate 108. Drive shaft 102 has a generally step cone shape with an upper portion 123, mid portion 124 and lower portion 125. Upper portion 123 has an upper tapped hole 156 for secure coupling to an arbor of an angle grinder. Lower portion 125 has a lower tapped hole 158 for secure coupling to drive assembly 104 with fastener 106, such as a threaded bolt. Lower portion 125 has a hexagonal shape corresponding to, and for mating reception in, hexagonal opening 107 in drive head 106. In other embodiments the corresponding shapes of lower portion 125 and opening 107 may be a suitable shape other than a hexagonal shape.

Angle grinder head 100 also an outer shroud 110 and an inner shroud 132. Outer shroud 110 and inner shroud 132 may be made of a rigid and durable material such as stainless steel and the like. The space between outer shroud 110 and inner shroud 132 defines a cavity 136 with negative pressure when the vacuum is operating.

Outer shroud 110 is generally cylindrically-shaped with an open bottom end. The top of outer shroud 110 has an opening 111 through which drive shaft 102 extends. Outer shroud 110 has an annular vertical sidewall 138. A vacuum port 112 is located on side of sidewall 138. Vacuum port 112 is configured to receive a vacuum hose of a vacuum device. Vacuum port 112 may simply be an opening. In other embodiments, vacuum port 112 may also include cylindrical projection that extends outwardly from the opening.

Inner shroud 132 is generally frustoconically-shaped with an open bottom end. Inner shroud 132 is concentrically disposed within outer shroud 110. The top of inner shroud 132 has an opening 134 through which drive components, i.e., drive shaft 102 and/or drive head 106 extend. The top of inner shroud 132 also includes three equidistantly spaced fastener openings 154. Inner shroud 132 has sidewalls 140 that taper outward at an angle 152 from the vertical. Angle 152 may range from about 10 to 30 degrees, or about 15 to 25 degrees, or about 20 degrees. Sidewalls 138 of outer shroud 110 may extend further downward than sidewalls 140 of inner shroud 132, allowing tool segments 209 of tool assembly 208 to work close to sidewalls 138 of outer shroud 110. Outer shroud 110 may be thin, for example less than 2 mm, or less than 1.5 mm, or less than 1.0 mm, to allow tool segments 209 of tool assembly 208 to work very close to obstacles (e.g. a wall or column). In some embodiments an outer dust shroud extension 212 may be detachably attached to outer shroud 110 to extend shrouding closer to the surface being worked when a larger tool assembly 208 is used (e.g. a bush hammer plate). Outer dust shroud extension 212 may be detachably attached to outer shroud 110 and cushioned, for example by hook and loop fastening. In some embodiments the additional extension beyond the lower edge of outer shroud 110 provided by outer dust shroud extension 212 may for example be up to 10 mm, or 20 mm, or 30 mm, or 40 mm.

The tapering of sidewall 140 creates a narrowing of cavity 136 between sidewall 140 of inner shroud 132 and sidewall 130 of outer shroud 110. The space between sidewall 140 of inner shroud 132 and sidewall 130 of outer shroud 110 at the lower edge of sidewall 140 defines an annular gap 142. The width of annular gap 142 may be between about 0.5 mm and 10 mm, or between about 1 mm and 5 mm. The inventor has determined that the narrowness of annular gap 142 significantly increases vacuuming of dust and debris generated during use of the angle grinder. The increased vacuuming results from the higher suction velocity due to the narrowness of the gap, and also due to the air being pulled substantially equally around the entire perimeter of the shrouds, drawing in more dust and debris than a conventional single shroud with a single dust port.

Angle grinder head 100 also has a bearing assembly 116 including a bearing housing 118, an outer race 120 and an inner race 122. Inner race 122 is engaged between a shoulder 126 of upper portion 123 of drive shaft 102 and drive head 106. Under load, i.e., when a operator presses downwardly on angle grinder head 100, this engagement is further secured. Thus in use, inner race 122 rotates together with drive shaft 102 and drive assembly 104. Bearing housing is fixedly connected at a top end to outer shroud 110 through three equidistant fastener openings (not shown), and a bottom end to inner shroud 132 through three equidistant fastener openings 134, via fasteners 155. Thus outer shroud 110, inner shroud 132 and bearing housing 118 are, together, independently and freely rotatable in relation to the drive shaft, drive assembly, and inner race.

The inventor has determined that this independent and free rotation provides a number of advantages. The side of outer shroud 110 with vacuum port 12 will have a vacuum hose 206 attached to it so that, during vertical operation of the angle grinder (e.g. polishing a wall), the weight of vacuum hose 206 would cause outer shroud 110 to freely rotate such that vacuum port 12 faces down no matter which direction the angle grinder was moving on the vertical surface. This allows the operator to use the angle grinder against a vertical surface and rotate or move the angle grinder in any direction and vacuum hose 206 would always hang down, that is the orientation of outer shroud 110 on the vertical surface remain constant, avoiding the resistance caused by awkward positioning of vacuum hose 206 (e.g. the vacuum hose extending from the angle grinder in an upward, diagonally upward, or sideways direction). Bearing assembly 116 ensures there is little resistance to outer shroud 110 freely rotating in this manner. The operator may also drape vacuum hose 206 over the operator's shoulder during use on a vertical surface and this will also keep outer shroud 110 in a fixed orientation. Independent and free rotation of outer shroud 110 from the drive components is important as it eliminates the resistance that the operator would otherwise encounter when using a standard fixed shroud with a fixed vacuum hose position.

When working on a horizontal surface independent and free rotation of outer shroud 110 allows the operator to position vacuum hose 206 in any convenient direction independent of the direction and movement of the angle grinder. Independent and free rotation also reduces operator fatigue as the operator is not fighting the resistance of a fixed shroud with fixed hose position, allowing the operator to rapidly and continuously change direction without having to force vacuum hose 206 to follow the angle grinder's movements.

Drive assembly 104 may also have a thrust washer 128 seated on a shoulder 130 of drive head 106. Thrust washer 128 prevents distortion of drive head 106 where it meets inner race 122, and also provides a surface on which inner race 122 is axially supported.

Annular seal plate 144 is also fixedly connected to inner shroud 132 by fasteners 155 through three equidistant openings in seal plate 144. Annual seal plate 144 supports axle seal 146 against drive head 106 to enhance sealing of bearing assembly 116 and in particular inner race 122. Similarly, bearing housing 118 is fittingly disposed between outer shroud 110 and inner shroud 132 to block ingress of dust and debris into outer race 120 and inner race 122.

Drive plate 108 houses an array of grommets 148. Grommets 148 may be equidistantly arrayed in multiples of three. Grommets 148 are disposed in a plurality of corresponding openings 150 in drive plate 108. Grommets 148 are configured to receive a tool assembly 208. Grommets 148 are made of a resilient material such as rubber, for example EPDM rubber.

The inventor has determined that using resilient grommets provides flexibility in the movement of tool assembly 208, allowing smooth movement over contours or rough patches of a surface being worked. The flexibility also keeps tool segments 209 of tool assembly 208 in full contact with the surface while following contours, facilitating smoother and faster grinding while also keeping tool segments 209 cooler. Maintaining cool tool segments 209 prevents them from overheating and glazing. Resilient grommets also allow the operator to put more downward force on the angle grinder head without stalling the motor and keep the angle grinder running smoothly with good control over the surface.

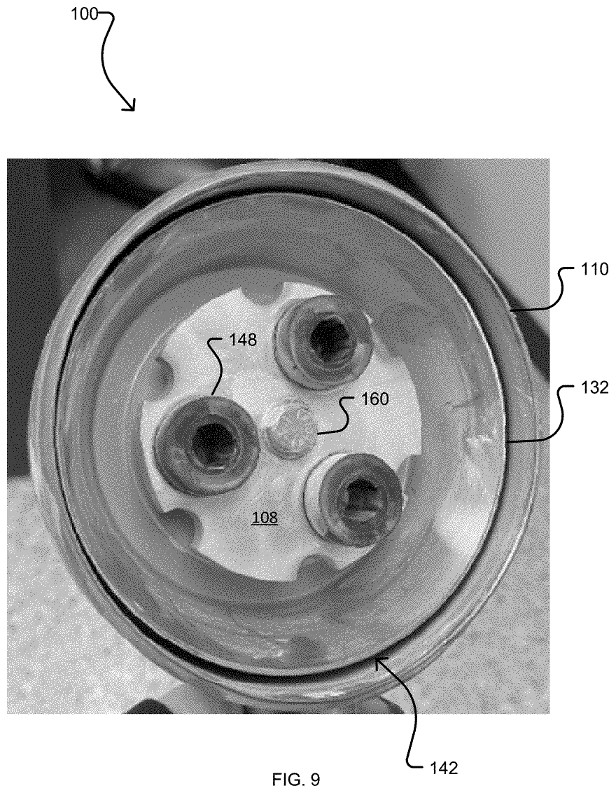

FIGS. 6 to 9 show an angle grinder 200 according to an embodiment utilizing an angle grinder such as angle grinder 100. As shown in FIG. 6, a vacuum hose 206 is coupled to vacuum port 112 of angle grinder head 100 by a clamp 210. As shown in FIG. 7, angle grinder 200 has a housing 202, with a motor inside (not shown). A side handle 204 projects perpendicularly from housing 202. Tool assembly 208 detachably engages grommets 148 attached to drive plate 108. In some embodiments, the tool assembly used with angle grinder 100 can be the same tool assembly used on a larger, floor machine (which uses multiple tool assemblies), so that the exposure and scratch pattern are consistent between surfaces worked by the angle grinder and the floor machine. For example the three-pin configuration of tool assembly 208 can be used on the floor machines described for example in U.S. Pat. No. 10,406,648 to Rogers, incorporated by reference in its entirety herein. FIG. 8 shows the top of drive shaft 102 and upper tapped hole 156 of angle grinder 100 detached from the rest of angle grinder 200. FIG. 9 shows angle grinder 100 with tool assembly 208 removed, and shows annular gap 142 between outer shroud 110 and inner shroud 132.

Where a component (e.g. shaft, head, plate, port, bearing, shroud, washer, race, housing, grommet, seal, fastener, etc.) is referred to above, unless otherwise indicated, reference to that component should be interpreted as including as equivalents of that component any component which performs the function of the described component (i.e. that is functionally equivalent), including components which are not structurally equivalent to the disclosed structure which performs the function in the illustrated exemplary embodiments of the invention.

While a number of exemplary aspects and embodiments have been discussed above, those of skill in the art will recognize certain modifications, permutations, additions and sub-combinations thereof. For example:

The sidewall of the outer shroud, instead of being vertical, may taper outwardly like the inner shroud. In such an embodiment the inner shroud may taper at a greater angle to achieve the narrow gap.

The narrow gap may be achieved by means other than a tapering of the sidewalls of the inner shroud and/or outer shroud. For example, an additional component (e.g. an annular wedge shaped component) may be added to the inner surface of the sidewall of the outer shroud, or to the outer surface of the sidewall of the inner shroud, to achieve the same narrowing effect.

Instead of fasteners and openings or other couplings described, at least some components may be formed integrally or welded together. For example, the drive shaft and the drive assembly may be an integral component.

Aspects of the invention need not be combined in a single embodiment. For example, in some embodiments the angle grinder head may have the features described herein for independent and free rotation of the shrouds in relation to the drive components, but without a narrowed gap between the shrouds, or even without an inner shroud. Or, in some embodiments the angle grinder head may have the features described herein for independent and free rotation of the shrouds in relation to the drive components, and the narrowed gap between the shrouds, but without resilient grommets.

Bearings may be of any suitable type, including ball bearings, plain bearings, fluid bearings and the like.

Various components may be of different shapes than illustrated in the embodiments described. For example, the lateral cross section of the outer shroud and the inner shroud, instead of circular, may be another shape such as oval.

It is therefore intended that the following appended claims and claims hereafter introduced are interpreted to include all such modifications, permutations, additions and sub-combinations as are consistent with the broadest interpretation of the specification as a whole.

1. An angle grinder head comprising:
a drive shaft;
a drive assembly comprising a drive head and a drive plate, the drive head coupled to the shaft;
an outer shroud comprising:
a vacuum port for attaching to a vacuum hose; and
a opening through which the drive shaft extends;
a bearing assembly comprising a bearing housing and an inner race;
wherein the inner race is engaged between the drive shaft and the drive head;
wherein the bearing housing is fixedly connected to the outer shroud;
whereby the outer shroud and the bearing housing are independently and freely rotatable in relation to the drive shaft, drive assembly, and inner race.

2. An angle grinder head according to claim 2 wherein the drive shaft comprises an upper portion, wherein the inner race is engaged between a shoulder of the upper portion and the drive head.

3. An angle grinder head according to claim 3 wherein the drive assembly further comprises a thrust washer, wherein the drive head comprises a shoulder for seating the thrust washer, and wherein the inner race is engaged between the shoulder of the upper portion and the thrust washer.

4. An angle grinder head according to claim 1 further comprising an inner shroud fixedly connected to the bearing housing, the inner shroud comprising a opening through which the drive assembly extends, the inner shroud and outer shroud defining a cavity therebetween.

5. An angle grinder head according to claim 4 wherein a sidewall of the outer shroud and/or a sidewall of the inner shroud tapers toward each another in the downward direction, whereby the cavity between the sidewall of the outer shroud and the sidewall of the inner shroud narrows in the downward direction to define a gap between the outer shroud and a lower edge of the inner shroud.

6. An angle grinder head according to claim 5 wherein the sidewall of the outer shroud extends lower than the sidewall of the inner shroud, and wherein the inner shroud tapers toward the outer shroud at an angle between about 10 degrees to 30 degrees, or about 15 degrees to 25 degrees, or about 20 degrees.

7. An angle grinder head according to claim 6 wherein the gap is annular.

8. An angle grinder head according to claim 6 wherein the gap is between about 0.5 mm and 10 mm, or between about 1 mm and 5 mm.

9. An angle grinder head according to claim 4 comprising an annular seal plate fixedly connected to the inner shroud, wherein an axle seal is disposed between the seal plate and the drive head to seal the bearing assembly.

10. An angle grinder head according to claim 4 wherein the bearing housing is fittingly disposed between the outer shroud and the inner shroud to seal the bearing assembly.

11. An angle grinder head according to claim 4 wherein the outer shroud is cylindrical, the inner shroud is frustoconical, and the inner shroud is concentrically disposed within the outer shroud.

12. An angle grinder head according to claim 1 wherein an array of resilient grommets in multiples of three are disposed in a plurality of openings in the drive plate, the resilient grommets configured to attach to a tool plate.

13. An angle grinder head according to claim 12 wherein the resilient grommets are made of rubber.

14. An angle grinder comprising:
a housing;
a motor inside the housing;
a handle projecting from the housing;
an angle grinder head according to claim 1, wherein the drive shaft of the angle grinder is drivingly connected to the motor; and
a tool assembly detachably connected to the drive plate of the angle grinder.
